(19) United States
(12) Patent Application Publication
(10) Pub. No.: US 2002/0161928 A1
(43) Pub. Date: Oct. 31, 2002

(54) Smart agent for providing network content to wireless devices

(76) Inventor: Awele Ndili, San Jose, CA (US)

Correspondence Address: WILSON SONSINI GOODRICH & ROSATI, 650 PAGE MILL ROAD, PALO ALTO, CA, 943041050

(21) Appl. No.: 09/965,137

(22) Filed: Sep. 26, 2001

Related U.S. Application Data
(60) Provisional application No. 60/239,421, filed on Oct. 10, 2000.

(51) Int. Cl. G06F 15/16

(52) U.S. Cl. 709/246

(57) ABSTRACT

A device is provided for delivering content to a mobile device from a network site where the mobile device and network site may each employ different communication protocols, programming and/or mark-up languages, and/or natural language formats relative to each other, the device comprising: computer executable logic taking a communication received from a mobile device corresponding to a request for content from a network site and identifying a communication protocol, a programming and mark-up language, and a natural language format employed by the mobile device; computer executable logic for determining which of the identified communication protocols, programming and mark-up languages, and natural language formats differ between the mobile device and the network site; computer executable logic for modifying the content in regard to whichever of the communication protocol, programming and mark-up language, and natural language format of the content differs between the mobile device and the network site such that each of the communication protocol, programming and mark-up language, and natural language format of the converted content matches the communication protocol, programming and mark-up language, and natural language format of the mobile device; and computer executable logic for causing the converted content to be transmitted to the mobile device in the communication protocol, programming and mark-up language, and natural language format of the mobile device.

### RELATED APPLICATIONS

This application claims the benefit of priority to U.S. Provisional Patent Application Ser. No. 60/239,421, filed Oct. 10, 2000 which is incorporated herein by reference in its entirety.

### BACKGROUND OF THE INVENTION

1. Field of the Invention

This invention relates to the field of network content delivery for wireless devices.

1. Description of the Related Art

Existing wireless devices have limited access to the Internet. In order to access network sites, a terminal or device must communicate with sites on the network through one of the network's protocols. Terminals such as personal computers communicate with the Internet through, for example, an HTTP protocol.

Wireless devices such as cell phones have limited bandwidth and data entry capacity. The limited bandwidth significantly reduces the number, quantity and quality, of web-sites that can be made available to the user. As a result, users of wireless mediums such as cell-phone networks often have limited choices in which web-sites they can visit, and also experience lengthy download times.

Other wireless devices such as the Palm VII have capabilities to communicate with the Internet in an HTTP protocol. However, due to bandwidth constraints, such hand-held computers have limited number of web sites available for browsing.

Other wireless devices such as cell phones and Sprint PCS® devices communicate with a network using a WAP protocol with HDML/WML content. To provide Internet type access to such devices, network sites are established in an HDML/WML format.

### SUMMARY OF INVENTION

A device is provided for delivering content to a mobile device from a network site where the mobile device and network site may each employ different communication protocols, programming and mark-up languages, and/or natural language formats relative to each other, the device comprising: computer executable logic taking a communication received from a mobile device corresponding to a request for content from a network site and identifying a communication protocol, a programming and mark-up language, and a natural language format employed by the mobile device; computer executable logic for determining which of the identified communication protocols, programming and mark-up languages, and natural language formats differ between the mobile device and the network site; computer executable logic for modifying the content in regard to whichever of the communication protocol, programming and mark-up language, and natural language format of the content differs between the mobile device and the network site such that each of the communication protocol, programming and mark-up language, and natural language format of the converted content matches the communication protocol, programming and mark-up language, and natural language format of the mobile device; and computer executable logic for causing the converted content to be transmitted to the mobile device in the communication protocol, programming and mark-up language, and natural language format of the mobile device.

The device may optionally further comprise logic for identifying a communication protocol, a programming and mark-up language, and a natural language format employed by the network site.

The logic used to identify a communication protocol, a programming and mark-up language, and a natural language format employed by the mobile device may access a database comprising communication protocol, programming and mark-up language, and natural language format properties of different types of mobile devices.

The logic used to identify a communication protocol, a programming and mark-up language, and a natural language format employed by the network site may also access a database comprising communication protocol, programming and mark-up language, and natural language format properties of different network sites.

The logic used to identify a communication protocol, a programming and mark-up language, and a natural language format employed by the network site may use returned communication header information.

The logic used to identify a communication protocol, a programming and mark-up language, and a natural language format employed by the network site may query the network site.

The logic used to identify a communication protocol, a programming and mark-up language, and a natural language format employed by the mobile device may use a serial number, device ID, or useragent of the mobile device to make the identifications.

The logic used to convert the communications to be exchanged may be capable of converting the communication between two, three, four or more different protocols.

The logic used to convert the communications to be exchanged may be capable of converting the communication between two, three, four or more different programming and mark-up languages.

The logic used to convert the communications to be exchanged may be capable of converting the communication between two, three, four or more different natural language formats.

The device may also optionally further comprise computer executable logic for providing a user interface by which a range of different mobile devices which may access content from the network site may be defined.

The device may also optionally further comprise computer executable logic for providing a user interface by which a range of different mobile devices which may access content from the network site may be defined based on the natural language format employed by the mobile device.

The device may also optionally further comprise computer executable logic for providing a user interface by which a range of different mobile devices which may access content from the network site may be defined based on the programming and mark-up language employed by the mobile device.

The device may also optionally further comprise computer executable logic for providing a user interface by which a range of different mobile devices which may access content from the network site may be defined based on the communication protocol employed by the mobile device.

A method is also provided for delivering content to a mobile device from a network site where the mobile device and network site may each employ different communication protocols, programming and mark-up languages, and/or natural language formats relative to each other, the method comprising: receiving a communication from a mobile device corresponding to a request for content from a network site; identifying a communication protocol, a programming and mark-up language, and a natural language format employed by the mobile device; determining which of the identified communication protocols, programming and mark-up languages, and natural language formats differ between the mobile device and the network site; modifying the content in regard to whichever of the communication protocol, programming and mark-up language, and natural language format of the content differs between the mobile device and the network site such that each of the communication protocol, programming and mark-up language, and natural language format of the converted content matches the communication protocol, programming and mark-up language, and natural language format of the mobile device; and transmitting the converted content to the mobile device in the communication protocol, programming and mark-up language, and natural language format of the mobile device.

In one variation, the method may further comprise identifying a communication protocol, a programming and mark-up language, and a natural language format employed by the network site prior to determining which differ.

According to the method, identifying a communication protocol, a programming and mark-up language, and a natural language format employed by the mobile device may comprise accessing a database comprising communication protocol, programming and markup language, and natural language format properties of different types of mobile devices.

According to the method, identifying a communication protocol, a programming and mark-up language, and a natural language format employed by the network site may comprise accessing a database comprising communication protocol, programming and markup language, and natural language format properties of different network sites.

Also according to the method, identifying a communication protocol, a programming and mark-up language, and a natural language format employed by the network site may comprise querying the network site.

According to the method, identifying a communication protocol, a programming and mark-up language, and a natural language format employed by the mobile device may use a serial number, device ID, useragent or other request header information of the mobile device to make the identifications.

### BRIEF DESCRIPTION OF THE FIGURES

FIG. 1 is a block diagram illustrating a system for retrieving and converting network content for a mobile device, under an embodiment of the invention.

FIG. 2 is a flow chart for a system that retrieves and converts network content for the mobile device, under an embodiment of the invention.

FIG. 3 is a flow chart for a system that accesses user-defined parameters to retrieve and convert network content for the mobile device, under an embodiment of the invention.

FIG. 4 is a flow chart for a system that paginates network content for the mobile device, under an embodiment of the invention.

FIG. 5 illustrates a database management system, under an embodiment of the invention.

FIG. 6 illustrates use of memory bins for the database management system, under an embodiment of the invention.

FIG. 7 illustrates a programming tool to build a database management system for providing instructions to a content engine such as described with FIG. 1, under an embodiment of the invention.

FIG. 8 illustrates a programmer user-interface for use with a system such as described with FIG. 7, under an embodiment of the invention.

FIG. 9 is a block diagram illustrating a smart agent for a conversion engine, under an embodiment of the invention.

FIG. 10 is a flow process illustrating use of a smart agent, under an embodiment of the invention.

FIG. 11 is a user-interface for configuring a smart agent, under an embodiment of the invention.

### DETAILED DESCRIPTION

Embodiments of the invention include a system that is responsive to a request from a wireless device for network content existing under an Internet protocol (IP). The system retrieves the network content, and converts the network content into a wireless mark-up language and/or protocol for the mobile device. Among other advantages, the system can react to the request from the mobile device to deliver the network content “on the fly”. This is in contrast to existing systems, which may require the wireless device to access only network sites operating under the corresponding wireless mark-up language and protocol.

Another embodiment of the invention provides a database management system to store instructions for responding to requests from a mobile device. The instructions enable a content engine to retrieve a network event and/or content from a network site operating under an Internet protocol. The instructions also enable the content engine to convert the network event from a format such as HTML and a protocol such as HTTP to a WAP or other wireless protocol with WML/HDML and other wireless language content formats. The instructions are provided in response to a request from the mobile device for a particular network content or event. Since the instructions are stored, the content engine is able to access the instructions and quickly respond to the request from the mobile device.

Another advantage provided by this embodiment is that mobile devices operating under a wireless mark-up language and/or protocol are able to access any network site using stored instructions. This enables a much greater range of sites to be available for the mobile device. In contrast, other systems require that the network sites operate under a specific wireless mark-up language and/or protocol in order to communicate with the mobile device. These other systems require greater programming effort and resources, and are thereby restrictive and more difficult to set-up.

Another embodiment of the invention provides a programming tool to enable programmers to rapidly build instruction sets for individual IP network sites. The instruction sets are stored so as to be available for mobile devices that request content from the corresponding network site. The instruction sets enable IP network content to be retrieved and converted for delivery to the mobile devices, with minimal programming or computing resources required.

In regard to the foregoing description, it is noted that this application also incorporates U.S. patent application Ser. No. 60/163,115, entitled Portal Corfiguration in Wireless Medium, to Moeller et al., filed Nov. 2, 1999; and U.S. patent application Ser. No. 09/513,554, entitled System and Automatic Data Retrieval on an Internet Protocol Network, to Ndili et al., filed on Feb. 25, 2000 by reference in their entireties.

A. System Architecture

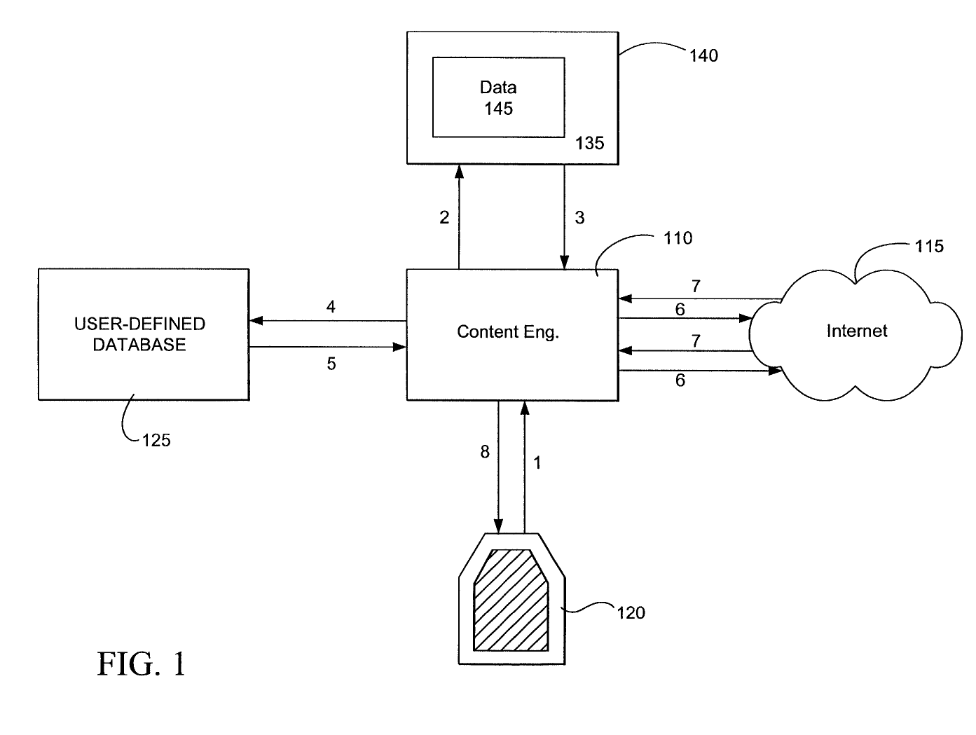

FIG. 1 is a block diagram of a system 100, under an embodiment of the invention. The system 100 includes a database management system (DMS) 140, a content engine 110, and a wireless mobile device 120. The DMS 140 includes a database 145 and a management system 135. The content engine 110 may access to a user database 125 comprising user-defined parameters. The content engine 110 retrieves network events from a network 115 and signals the network events to mobile device 120.

The mobile device 120 includes any device that can use a wireless medium to access a network such as the Internet. Possibly, mobile device 120 is wireless access protocol (WAP) enabled. Examples of mobile devices 120 include, but are not limited to, cell-phones, PCS phones, pagers and handheld devices including PocketPC and Palm devices. The mobile device 120 communicates with content engine 110 through the wireless medium.

The mobile device 120 may include an application for signaling network events or content to the user. For example, the mobile device 120 may include a browser to view network sites in a wireless markup language including for example wireless mark-up language (WML), handheld device markup language (HDML), compact hypertext mark-up language (cHTML), mobile mark-up language (MML) and other wireless formats. A screen on the mobile device 120 may include user-interactive features and an interface to allow users to interact with a network site after viewing a network event.

As used herein, network events include content provided on a network site. Content includes all or portions of web pages available on web sites. For example, network content includes text, images, banners, media files accessible on the site, and links to other sites. Network pages (paging, push messaging) are another example of such content.

Network events also include electronic messages, as well as web-based events associated with specific sites on the Internet. Electronic messages include emails, instant messages, files existing as attachments to electronic messages, programmatic notifications of events generated by server-side modules of third parties (stock alerts), and multimedia type messages. For example, network events include emails from an HTTP or POP3 protocol. Web events may be associated with an HTML link that accesses the web event. Web events also include text or media resources appearing or linked to web pages.

Network events may also include a series of interactions with server-side modules that are accessible through links. Network interactions may include prompts from server-side modules. For example, e-commerce applications provide access to servers that receive purchasing information for a selected item. Network events also include real-time information appearing on, for example, a web page

The DMS 140 includes a database 145 and a management system 135. The database contains instructions for content engine 110 to retrieve network events from network 115. The instructions define how the specific network event is retrieved and converted to a medium for the mobile device 120. In an embodiment, the instructions stored in database 145 specify which network sites are to be accessed in response to a request from a user, what network events are to be retrieved from the network site, and in what manner the network events are to be instructed. The instructions in database 145 may be predetermined or user-defined. The user may access a terminal to configure instructions for DMS 140.

The content engine 110 receives instructions from DMS 140 to retrieve network events available under an Internet protocol (IP), and converts the network event to a wireless mark-up language or page for the mobile device 120. For example, content engine 110 converts network events available under an HTTP/HTTPS protocol into a wireless mark-up language available under the WAP protocol.

In an embodiment, the content engine 110 may be instructed to deliver content from network sites or otherwise modify the content according to user-specified parameters stored in a user database 125. The user database 125 may be configurable by users operating terminals coupleable to the Internet through an HTTP protocol. In one embodiment, each user accesses an account on user database 125 to specify one or more types of network events that need to be retrieved for mobile device 120. The users may also specify parameters on how the network events are to be converted and transmitted to mobile device 120. For example, the user may specify the frequency at which a particular network site is to be checked for selected network events. In addition, the user may specify the type of content that should be located and signaled to the wireless device.

FIG. 1 illustrates communications transmitted between mobile device 120 and other components in system 100, under an embodiment of the invention. In a request 1, a user of mobile device 120 specifies a card to be retrieved from network 115. The card may correspond to an IP network site, such as a web site on the Internet. The card may be a number that uniquely defines the address of the network site. The user of mobile device 120 may—specify the card through an input mechanism such as a touchpad, button, or graphic user-interface. In one embodiment, the user configures the mobile device 120 to display one or more use-interactive features, such as a bookmark, to enable an easy input mechanism for accessing the network site. The request 1 may also identify either the user or the device identification.

In response to receiving request 1, content engine 110 signals a request 2 to DMS 140. The request 2 locates instructions for the card specified in request 1. The DMS 140 matches the request 1 to one or more instructions in database 145.

The content engine 110 receives from DMS 140 a response 3. The response 3 includes the instructions specified by request 2. The card specified in request 1 determines the number of instructions included in communication 2. The instructions specify the network event or content to be retrieved from the network site identified by the card as well as instructions for processing and preparing the data for display on the mobile device 120.

In an embodiment, once instructions in response 3 are received, content engine 110 signals to retrieve the network events from the specified network site. In an embodiment, content engine 110 may signal 4 user database 125 to retrieve user-defined parameters 5 that affect, access or identify the content or event on the card specified in request 1. The content engine 110 may signal 4 user database 125 to retrieve user-defined parameters 5 before or after accessing the network site specified by the card.

The content engine 110 signals 6 the network 115 to access the network site or sites specified in response 3. The network event 7 is fetched or received from the network site. The content engine 110 assembles or creates content for mobile device 120 using card build instructions from response 3 and/or user specific and/or defined data from response 5. The content engine 110 transmits a signal 7 containing the content to the mobile device 120.

In embodiments of the invention, request 1 may cause several communications to occur between content engine 110, DMS 140, user database 125, and network 115. For example, response 3 from DMS 140 may contain instructions to retrieve multiple network events or content from the network site specified by the card. The instructions in response 3 may identify network events or content available on the specified network site over a duration of time to be retrieved by content engine 110. In addition, the user database 125 may provide parameters 5 requiring several interactions between the content engine 110 and the network site specified by the card.

As a specific example, a user may specify in request 1 a card to a stock quote site on the Internet. The instructions in response 3 may cause content engine to repeatedly retrieve a stock quote from the network site. To identify the stock, the content engine 110 may access user database 125 to identify one or more stocks (parameters) previously specified by the user. The stocks are signaled 6 to the network site. The stock quote for each stock specified as a parameter in user database 125 is signaled as network event 7 each time the stock quote is retrieved from the network site. In this way, the user has to only specify a card in the DMS 140 to receive several stock quotes and/or other data. In an embodiment such as described, the user does not have to specify the stock from mobile device 120, or make separate requests for each stock quote.

Examples of network sites that can be retrieved under the example above include web sites to brokerage houses, stock pages on portals (Yahoo®, Lycos(®), and streaming quote sites. The flexibility of system 100 may be shown with another example. For web sites of brokerage houses, once response 3 is received from DMS 140, content engine 110 accesses user database 125 to retrieve log-in, password, and other account information. The content engine 110 is then able to access the stock quote page of the user's account automatically, with no input from wireless device 110 other than request 1.

In an embodiment, communications illustrated by numerals 1-7 are carried out “on the fly”, in response to one another. The communications can simulate a real-time data exchange to the user. The rapid and robust content provided to the user in response to request 1 is in contrast to other devices, which have limited accessible network sites and bandwidth.

B. Processes for Converting IP Network Events to Wireless Protocol

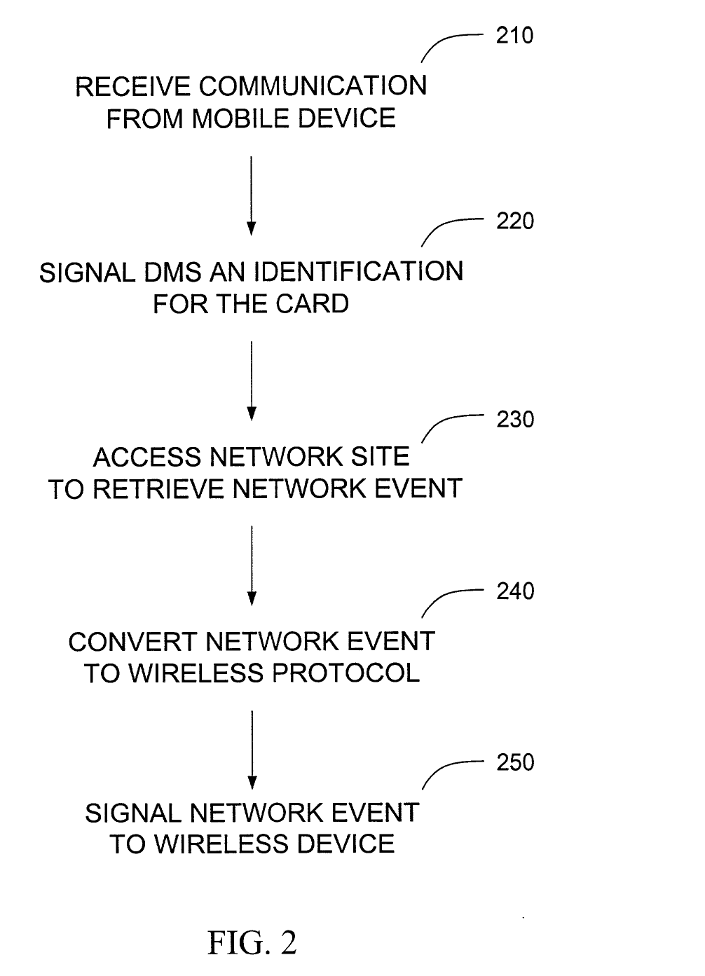

FIG. 2 illustrates a method detailing how content engine 110 interacts with mobile device 120, under an embodiment of the invention. For illustration, the process is described with reference to an uniform resource locator for an e-commerce site. The process details retrieving a network event or content from an IP network such as the Internet, and then transmitting the event or content to mobile device 120.

In step 210, content engine 110 receives a communication from the mobile device 120 that includes a card corresponding to the URL, along with an identifier of the mobile device 120. The communication is transmitted through a wireless medium.

In step 220, the content engine 110 may signal DMS 140 an identification for the card to retrieve instructions for assembling the content available on the URL for the mobile device 120. The content engine 110 may communicate with DMS 140 over a network such as the Internet. The instructions are for the URL of the e-commerce site. Instructions that may be provided include commands to “fetch” the URL, display the header and title for the URL, remove header tags, display a welcome message provided on the URL, and exact a pertinent section of the web page located by the URL. In an embodiment, the selected instructions are based on the identification of the card provided to the DMS 140. In another embodiment, the instructions may also be modified or otherwise configured for the URL based on the card identification. In another embodiment the content engine 110 may skip step 220 and proceed to step 230 based on predefined instructions.

In step 230, the content engine 110 accesses the network site located by the URL to retrieve specific network events. The network events are identified from the instructions received from DMS 140. The network events may be retrieved from the network site, or other links internal to the network site. For example, the content engine 110 may locate a home page of an e-commerce site, then select categories and locate a merchandise item for transmission to mobile device 120.

In step 240, content engine 110 converts the network event(s) into a wireless format for mobile device 120. In one embodiment, content engine 110 reformats the network event or content into a wireless format. For web sites, the event and content may be converted from an HTML format to the HDML, WML or other wireless formats. For example, HTML tags of the network event or content are programmatically converted into WML, HDML or other wireless mark-up language tags. Further details on converting HTTP or other IP protocol events into WAP, with HDML, WML, or other wireless formats for WAP enabled devices are disclosed in U.S. patent application Ser. No. 60/163,115, entitled Portal Corfiguration in Wireless Medium, to Moeller et al., filed Nov. 2, 1999, incorporated by reference herein.

In step 250, the content or network event is transmitted in the wireless protocol to mobile device 120. The network event or content may be formatted or otherwise paginated for a display of mobile device 120.

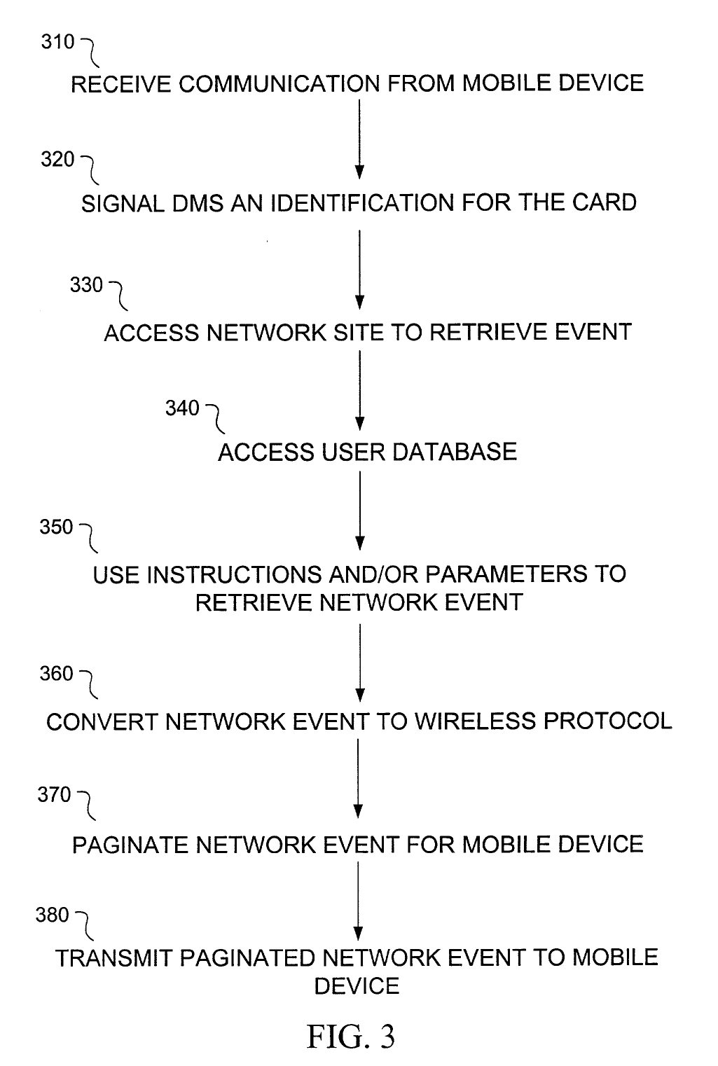

FIG. 3 illustrates another process in which user database 125 is accessed to provide network events and content to mobile device 120. In step 310, the content engine 110 receives a card request from the user of mobile device 120 specifying a network site or sites, or resource. In step 320, instructions for the specified network site or sites, or resource are retrieved from DMS 140. In step 330, the network site or sites, or resource is accessed.

In step 340, content engine 110 accesses user-database 125 to determine if user-defined parameters exist for the network site. In an embodiment, the user of mobile device 120 provides user-defined parameters. The parameters affect content engine 110 in selecting and accessing the network event for mobile device 120. The parameters may also affect content engine 110 in configuring and/or delivering the network event to the mobile device 120. A configurable database for storing parameters for user database 125 is disclosed in U.S. patent application Ser. No. 09/513,554, entitled System and Automatic Data Retrieval on an Internet Protocol Network, to Ndili et al., filed on Feb. 25, 2000, and incorporated by reference herein.

In an embodiment, the user-defined parameters stored in user database 125 are maintained in accounts. The user of mobile device 120 may configure the accounts to include preferred parameters. Examples of parameters that may be specified in user database 125 include login and password information to a particular site, such as an e-mail site, or a proprietary information site. A user may also specify as a parameter the frequency in which a network event or content is retrieved once the network site is accessed by content engine 110. As another example, for an auction site, the user may specify a specific search term or auction item as a parameter.

In step 350, content engine 110 combines instructions and parameters to access the network site and retrieve network events and content. The instructions and parameters combine to control the content engine 110 in accessing the network site specified by the card signaled from the mobile device 120.

In step 360, content engine 110 converts the network event from the IP protocol with HTML, XML or other format to WML, HDML or other wireless formats with WAP or another wireless protocol. In step 370, content engine 110 paginates the converted network event or content for mobile device 120. In step 380, the network event or content is transmitted to mobile device 120.

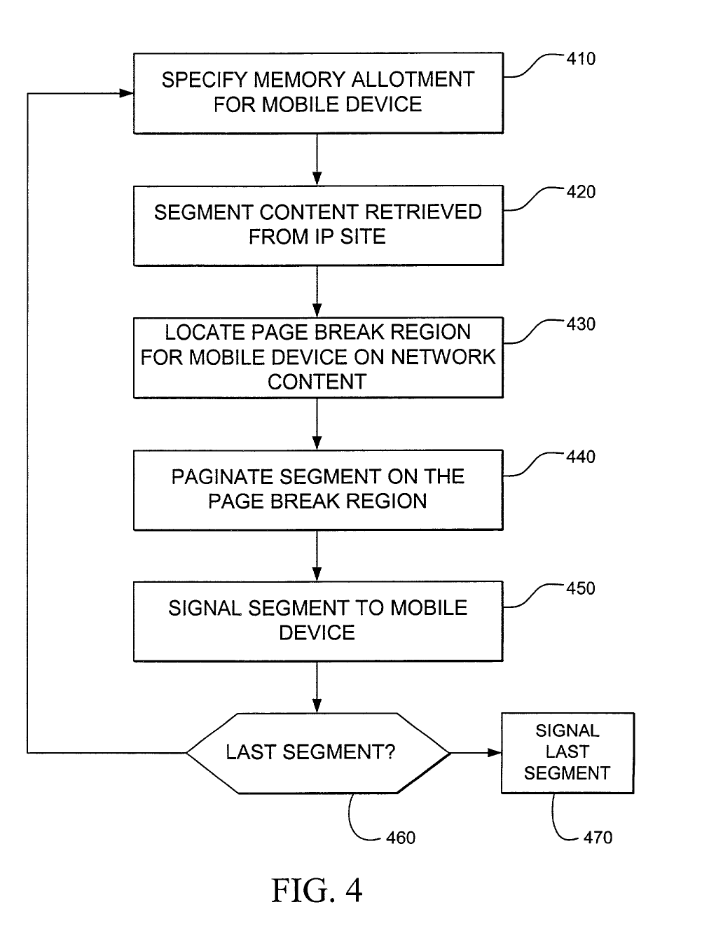

FIG. 4 illustrates a method performed by content engine 110 in paginating the converted network event into the wireless format. A process such as described with FIG. 4 enables events to be retrieved from IP sites and then converted for mobile devices 120. The content appearing on mobile device 120 is properly paginated for the screen of the mobile device 120, with no modification at the network site 115. The process described with FIG. 4 assumes that content engine 110 has retrieved the network content from the network 115.

In step 410, a memory allotment is specified for mobile device 120. The memory allotment depends on the wireless protocol in use, and the desired page size which can be a function of the memory and screen size of target mobile device 120. The memory allotment may be designated as, for example, 1.4k, representing the average memory buffer size of WAP enabled mobile phones. Alternatively, a user of mobile device 120 may configure the memory allotment depending on the specific type and model of mobile device 120 being used. In an embodiment, the memory allotment is specified through user database 125.

In step 420, the content retrieved from the IP site is converted and segmented according to the memory allotment. Each segment is portioned to correspond approximately to the memory allotment. The size of the segments allows each segment to be displayed in its entirety as one page on mobile device 120. As an example, if a converted journal article from a web site is 24k in length, the article is segmented roughly into 24 1k segments for a 1k buffer sized mobile device.

In step 430, a page break line or region is located on the retrieved and converted network content corresponding to the boundary of each segment. The content engine 110 may locate a line or region where the 1k break occurs.

Then in step 440, each segment is paginated on that page break line or region to ensure that the cut-off to a next segment is made at an appropriate place. If a segment of converted network content retrieved from the IP site is not paginated properly, HDML or WML or other wireless format syntax may fail. In addition, words may be split up incorrectly to appear on different pages of the mobile device 120.

In an embodiment, a free unattached space is located to correctly paginate each segment within the page break region. For HTML coding, for example, the free unattached space must be positioned outside of tags and tag pairs appearing in that portion of the network content. Specifically, the content engine 110 locates spacing outside of HTML open end and close end tags. As an example, the line of coding appearing in a page break region may be:

<a href=www.mobileshift.com>click here<br>to see</a>

The content engine 110 identifies spaces before “<a href”, and after “</a>” as places where a legitimate page break may occur. The content engine 110 ignores spaces falling between the opening and closing of the <a>. . . </a>tags. In this way, the page displayed on the screen of mobile device 120 contains entire words and code segments, and is coded appropriately in the wireless mark-up language which could be, for example, WML, HDML or HTML.

To ensure the free unattached space is not between an open and close tag bracket, the content engine 110 may include coding that measures on the page break region the distance between the first located space and an open tag “<”. The coding then measures the distance between the located space and the close tag “>”. If the distance between the located space and the open tag is less than the distance between the located space and the close tag, then the located space is considered free and unattached, that is, the located space is not part of any tag. If the distance between the located space and the open tag is greater than the distance between the located space and the close tag, then the located space is considered attached. A next space is then located in the page break region. The next space may correspond to the space appearing to the right of the close tag. The spaces appearing in the page break region are checked in this manner until a free unattached space is located. In addition, this space then needs to be inspected to ensure that it is not within a coupled open tag/ close tag pair such as “<a>” and “</a>”. The same distance measuring algorithm is used to ensure that the selected space or chosen page break point is external to a coupled open/close tag pair. Once these two conditions are verified, the located space or page break point is then made the location of a page break and the segment is paginated.

In step 450, the segment is sent to mobile device 120. The next segment may be indicated with a user-interactive feature (icon) to show the availability of a next segment. Upon activation of the request for the next page, in step 460, a determination is made as to whether a next segment is the last segment for the network content. If in step 460, a next segment is a last segment, then the last segment is signaled to mobile device 120 in step 470 as the last segment. If there is another segment, then steps 410-460 are repeated.

C. Database Management System

Under an embodiment, DMS 140 manages a database of instructions that are selectively signaled to content engine 110 in response to content engine 110 receiving a request from mobile device 120. The instructions stored with DMS 140 each include one or more commands pertaining to retrieving and converting IP network content to, for example, a wireless format available under the WAP or other wireless protocol. The DMS 140 is configured to instruct content engine 110 to retrieve and convert IP network events responsive to inputs from mobile device 120, without requiring mobile device 120 to communicate using an IP protocol, and without requiring network 115 to provide content using a WAP protocol.

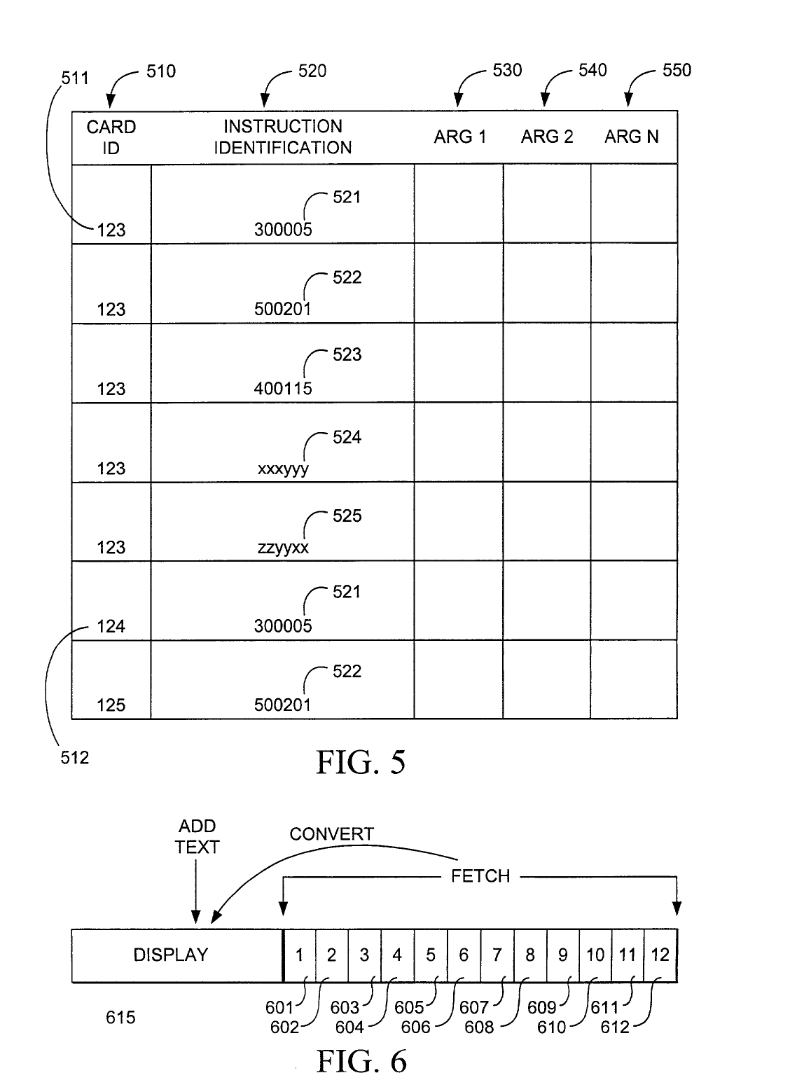

FIG. 5 illustrates a configuration of DMS 140, under an embodiment of the invention. According to this embodiment, DMS 140 is organized into a spreadsheet like format. A first column 510 lists card identifications 511, 512. A second column 520 lists instruction identifications 521-525. A third column 530, fourth column 540, and thru to an nth column 550 list arguments. To make a network site accessible to content engine 110, a programmer or editor of DMS 140 lists cards in the first column 510, selects instructions for column 520, and provides arguments for the instructions in columns 530-550. In alternative embodiments, a developer of wireless applications or a user of mobile device 120 may access and configure DMS 140.

The instruction identifications 521-525 correspond to one or more commands that have to be performed by content engine 110. Examples of instructions that may be specified in column 520 includes:

fetch: retrieves content or event from network site, places content into a drop bin;

convert: converts network content in drop bin from IP to WAP, places converted content in a display bin;

add text: drops content from DMS 140 or drop bin into display bin; and

split page: paginates content for mobile device.

The instructions listed above are exemplary, and several other instructions may be readily apparent to enable IP network content to be converted to WAP content. Examples of other instructions that may be used include, but are not limited to skip text, extract phrases, and skip end character.

The instructions include one or more commands. For example, convert may include routines to identify and remove HTML tags from a page retrieved from a web site. In such instances, convert may include commands to insert HDML, WML or other wireless mark-up language tags in appropriate places that correspond to the HTML tags. Certain tags on HTML pages may be identified and ignored. Other wireless mark-up language tags may be added automatically.

Preferably, the identifiers to the instructions are numeric, and are indicative of the instruction. For example, one or more numerals in the instruction identifier may represent that the instruction involves displaying content. In other embodiments, other symbols may be used to identify the instructions, such as shown by instruction identifiers 524 and 525.

The first column 510 includes cells that list each card multiple times. In an embodiment, a card occupies two or more cells in first column 5 10. The number of cells occupied by each card corresponds to the number of instructions each card requires.

The arguments contained in the third column 530, fourth column 540 and thru the nth column 550 are for the instructions specified in second column 520. The arguments may be provided by the programmer for each instruction provided for a card. The arguments may also be predefined for each instruction.

The arguments listed in each column 530-550 may be specific to certain instructions, or applicable to all instructions for a card. In one of the columns 530-550, the arguments specify a sequence in which the instructions are executed by content engine 110. For example, when a card is specified by mobile device 120, the arguments may specify content engine 110 to first fetch network content, then add text, and then convert the network content to WML, HDML or other wireless formats. When another card is specified by mobile device 120, content engine 110 may specify content engine 110 to first fetch the content, then convert the content to WML, HDML or other wireless formats.

In an embodiment, the argument for one of the columns 530-550 identifies the URL of the IP network site. Each card in DMS 140 includes at least one instruction specifying the content of the card.

In an embodiment, each card may include a fetch instruction. Each fetch may include an argument to identify whether the network content or event being retrieved is secure or unsecure. Each fetch may also include an argument to identify whether the command is a “get” for retrieving content from the IP site, or a “post” to provide additional information to the IP network site when retrieving events. Each argument for fetch occupies one of the columns 530-550. One or more of the arguments for fetch may be applicable to other instructions.

Another argument may specify whether user-defined parameters exist for the card. The card may include an additional fetch to retrieve the parameters in the user database 125. The identification of mobile device 120 may specify the applicable account in user database 125 for the user of mobile device 120. In an embodiment, fetch to retrieve the user-defined parameters is specified by arguments to be executed before fetch to retrieve network content from the IP site. Once the parameters are retrieved from user database 125, the fetch to retrieve the network content from the IP site includes the user-defined parameters. For example, the parameters may be contained as a tail portion of the URL to the IP network site.

Another example of an argument specified for one or more instructions, including fetch, is a specific memory bin for the instruction to use. Additional details on memory bins are provided with FIG. 6.

FIG. 6 illustrates memory bins which may be used to retrieve network content and convert the network content from an IP protocol and language to the wireless protocol and language. The memory bins are used by the instructions to retrieve network content and convert network content to the wireless format. An embodiment such as shown by FIG. 6 includes a display bin 615, and a plurality of drop bins 601-612. For illustration, operation of basic instructions fetch, convert, and add text are shown in combination with drop bins 601-612 and display bin 615 to convert data retrieved from IP network sites to a format for mobile device 120. Other instructions may be used, depending on the card.

When content engine 110 executes fetch, one of the arguments specify a drop bin 601-612 where the network content or event is deposited. One of the drop bins 601-612 may be designated as a default. Multiple drop bins 601-612 may be used when a card requires fetch to be executed multiple times on one or more network sites.

When content engine 110 executes convert, the network content from any of the specified bins 601-612 is converted to the wireless mark-up language and deposited in display bin 615. When content engine 110 executes add text, content for mobile device 120 is added to display bin 615. When all instructions are completed, the content of the display bin 615 is signaled to mobile device 120. The content may then be signaled to the mobile device 120 in a wireless protocol

As illustrated with FIGS. 5 and 6, DMS 140 enables content engine 110 to use stored instructions for near real-time retrieval, conversion, construction, and delivery of WAP content to mobile device 120. The stored instructions minimize computation resources required from content engine 110, so as to enable content engine 110 to provide WAP content as an immediate response from a user of mobile device 120.

In one example, DMS 140 includes instructions for a brokerage site. The brokerage site is requested by the user of mobile device 120. The request is identified as a card 511, 512 in column 510 of FIG. 5. The card includes arguments identifying the URL of the brokerage site in column 530-550. The instructions include a first fetch to retrieve password and login information from user-database 125. The first fetch is signaled with identification to identify the user account, signaled with the request from mobile device 120. The first fetch includes arguments to retrieve information from the user-database 125. A second fetch pushes the password and log-in information to the brokerage account as parameters to the URL for that network site. This second fetch retrieves account information from the network site. The account information is dropped in drop bin 601. The card may subsequently specify a convert instruction to convert the information in memory bin 601, and to deposit the converted information into display bin 615. The contents of display bin 615 are then signaled to mobile device 120.

In another example, DMS 140 includes instructions for comparison shopping. Multiple network sites may be accessed for a single card to present information from multiple network shopping sites. Alternatively, one site may be specified in the card which then automatically accesses other shopping sites. The content retrieved from the multiple sites are individually deposited in respective drop bins 601-612. Another instruction to compare the contents of the memory bins 601-612 may be executed. The comparative result may be placed in a WML, HDML or other wireless formats and placed in display bin 615. The contents of display bin 615 are then signaled to mobile device 120.

D. Programmer Interface for Developing DMS

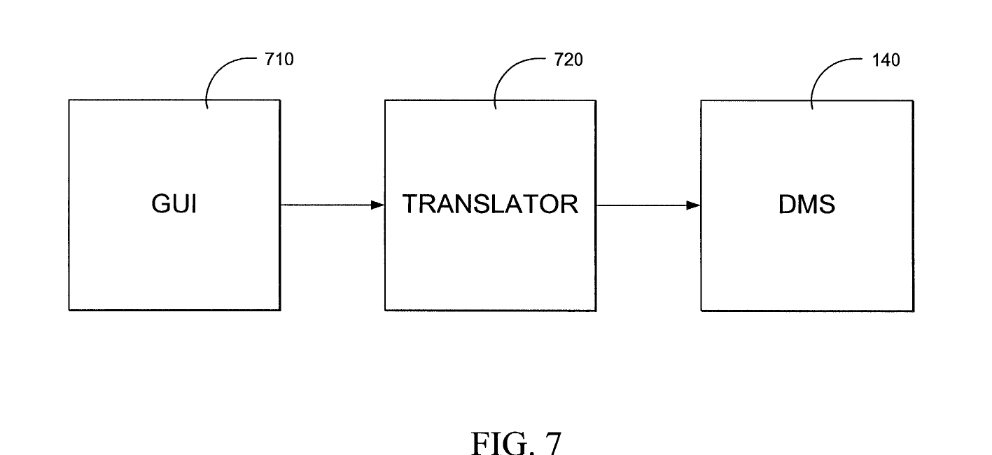

FIG. 7 illustrates a system for enabling a programmer to develop instructions for a management system such as described with DMS 140. The system includes a graphic user-interface (GUI) 710, a translator 720, and DMS 140. The DMS 140 may be part of a system such as described with FIG. 1.

In an embodiment, the GUI 710 displays objects to enable a programmer to select instructions. The instructions may appear as part of a display, or as user-interactive features such as icons. The GUI 710 also displays features and objects to enable the programmer to select arguments for the instructions. In addition, the GUI 710 may include other features, such as text fields to enable the programmer to add text for delivery to mobile device 120.

The translator 720 converts the selected objects and other input from the programmer for DMS 140. In an embodiment, translator 720 converts selected instructions into the numerical format shown in FIG. 5. Preferably, translator 720 identifies each input from the programmer and locates a position for the input in the chart shown by FIG. 5.

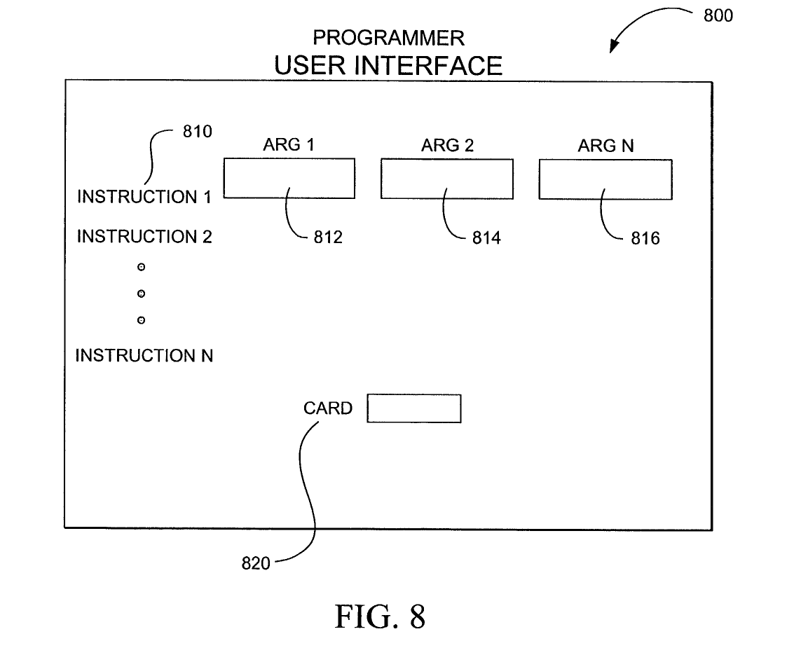

FIG. 8 illustrates an exemplary user-interface 800 for use with an embodiment of the invention. The user-interface 800 lists instructions 810 available for DMS 140 in one portion. The programmer may select instructions using icons or other user-interactive selection feature. The user-interface 800 may also display argument fields 812, 814, and 816. The argument fields may be in the form of text fields, where the programmer enters argument data for DMS 140. An identifier 820 identifies the card for which the instruction set is being built. The identifier 820 may be a programmer-input, or be automatically generated when the programmer specifies a resource identifier for the set of instructions.

As an example, the programmer may specify multiple instructions, including fetch and convert, from one of the listed instructions 810. The programmer then identifies the URL as one of the arguments 812-816. The programmer may also use another of the arguments 812-816 to specify whether the card or the instruction is secure or unsecured. Similarly, the programmer may use another one of the arguments 812-816 to specify whether the information is pushed or retrieved from the network site. Other arguments may be added in a similar fashion.

An advantage provided with system 700 and user-interface 800 is that programmers may simplify the process of storing instructions in DMS 140. The simplified process enables content engine 110 to retrieve network events and contents from many sites. Further, the simplified approach avoids the need for more complicated programming that may otherwise hinder the rapid development of wireless applications.

E. Smart Agent for Identifying Formats, Protocols and Languages

An embodiment of the invention relates to a programmable agent that implements conversion modules for exchanging communications between a mobile device and a network. The conversion modules may be used to make characteristics of a mobile device conform with characteristics of the network site being requested, where differences in the characteristics would otherwise preclude communications between the mobile device and the network site. Embodiments of the invention include conversion modules that convert the communication protocol, programming and mark-up language, and/or natural language format of communications exchanged between the mobile device and the network. According to these embodiments, the agent identifies the mobile device to implement the conversion modules and to render network pages based on the type of mobile device detected and its profile.

The use of specific conversion modules is intended to be exemplary. Alternative embodiments may implement other types of conversion modules to make the mobile device conform with other characteristics of the network site.

In an embodiment, the mobile device is WAP enabled, programmed in languages such as HDML, WML, or CHTML, and includes a natural language format for countries and geographic regions such as Japan, United States of America, and France. The agent is implemented with or coupled to an engine to receive a communication from that mobile device. In response, the agent routes the communication to appropriate conversion modules, retrieves content from the network site, and routes the content to appropriate conversion modules so that the network page can be rendered as requested on the mobile device. In this way, the agent enables the mobile device to access network sites regardless of protocol, language, or programming differences between the mobile device and the requested network sites.

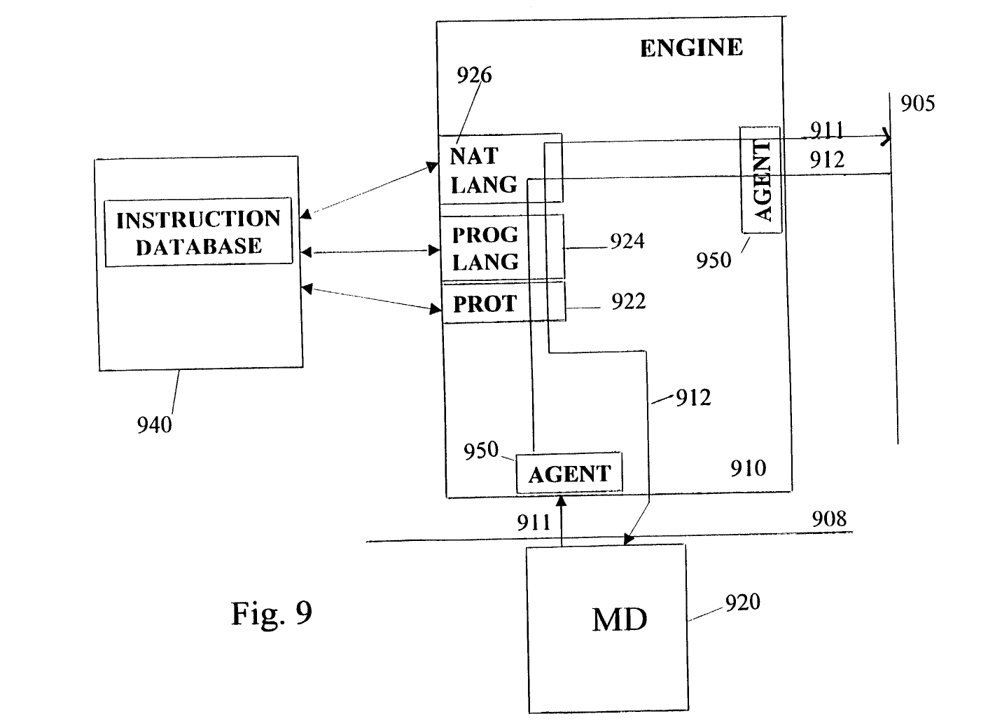

In an embodiment, as illustrated by FIG. 9, an agent 950 is a module within content engine 910. The mobile device 920 is coupleable to content engine 910 via a wireless network 908. A network 905 is accessible to the content engine 910. The network 905 includes target sites that the content engine 910 can access when requested by mobile device 920. In one embodiment, network 905 is the Internet, and wireless network 908 is a WAP link.

The content engine 910 also includes a protocol module 922, a programming and mark-up language module 924, and a natural language module 926. Preferably, each module accesses a database 940 to retrieve an instruction set for performing a stated task or function of the module. The instructions that are retrieved are based on the type of communication being exchanged between the mobile device and a selected network site. The modules may identify the mobile device and the network site being requested in selecting instructions for retrieval. Each module may also have all necessary instructions built-in, obviating the need for a database.

The protocol module 922 is programmed to convert the protocol of a communication exchanged between the mobile device 920 and wireless network 908. For example, the protocol module 922 may convert a WAP communication from the mobile device 920 to an IP communication, or convert protocol from network 905 from the IP protocol to the WAP protocol.

The programming module 924 uses an instruction set retrieved from database 940 to convert communications between the mobile device and the network from one language to another. The programming and mark-up language of the mobile device 920 may, for example, be one of HDML, WML, CHTML. The programming and mark-up language of the network sites may, for example, be one of HTML and JavaScript, XML, or CHTML.

The natural language module 926 uses an instruction set retrieved from database 940 to convert communications between the mobile device and the network from a format designed for a first type of natural language to a format designed for a second type of natural language. Natural language renders to human spoken languages, or dialect. Network sites, such as web sites, are often formatted to reflect a specific natural language. The natural language used by the network sites often corresponds to the geographic region or country of the network sites. Each natural language format includes specific letter characters, and other features to reflect cultural language differences in the manner data is to be entered or displayed. For example, network sites programmed for a Japanese audience include formatting to display Japanese characters, as well as formatting to receive Japanese characters as entry. Further, the Japanese characters may be formatted to appear vertically on a page.

FIG. 9 illustrates an example where mobile device 920 makes a request 911 for content from a network site. For this example, the network site being requested is assumed to have a different programming and mark-up language and human language format. For example, the mobile device 920 may be an HDML type device formatted to display English web sites. The request may be for a HTML or CHTML site formatted to provide content in Japanese.

The request 911 is received by agent 950. The agent 950 uses the request 911 to identify the type of mobile device. The agent 950 can determine other characteristics of the mobile device when the mobile device is identified. In one embodiment, request 911 can be used to identify the programming and mark-up language and the natural language of the mobile device 920. The agent 950 also determines the programming and mark-up language of the network site being requested. The agent 950 makes a determination as to whether the programming and mark-up language and the natural language used by the mobile device 920 matches the same characteristics of the network site.

In performing its functions, agent 950 may access database 940 to determine characteristics of the mobile device 920, as well as the network site being requested. The agent 950 may use request 911 to determine the type of mobile device, the programming and mark-up language for that type, the natural language being used, and the protocol in which the mobile device 920 uses to communicate.

Upon receiving request 911, agent 950 may determine the communication protocol and programming and mark-up language used by the network site. In one embodiment, information about a particular network site is pre-stored in database 940. In another embodiment, agent 950 may query the network site to retrieve the identification information.

In the example where mobile device 920 is an HDML type device, request 911 is routed through protocol module 922. The protocol module 922 converts request 911 from a WAP communication to an IP communication. For example, if Internet access is desired, the protocol module 922 converts request 911 into HTTP.

The agent then causes request 911 to be routed to programming and mark-up language module 924. The programming module 924 converts the request 911 from HDML to the language used by the requested network site. As mentioned, the language of the requested site may be identified using database 940, or separately by agent 950 signaling a query to the network site. In an embodiment, the programming module is adapted to convert the communication from HDML to HTML or CHTML.

Examples of HDML to CHTML conversions is provided in U.S. patent application Ser. No. 09/686,125, entitled System for Converting Wireless Communications for a Mobile Device, filed Oct. 10, 2000, said application being hereby incorporated by reference.

In an embodiment, request 911 is signaled to the requested network site. The agent 950 remembers the natural language of the mobile device 920 when response 912 is received from the network site. The agent 950 also receives the response from the network site. In this way, response 912 can be recognized as having a different natural language format. Then, response 912 is signaled to natural language module 926. If the natural language of the requested network site is identified to be Japanese, the natural language of the network site is converted by natural language module 926 to English. This process may use instruction sets provided by database 940. Among some of the conversion steps that may be performed, converting the natural language of the response 912 includes reformatting input features to recognize a character set from Arabic alphanumeric characters.

The response 912 is signaled to programming module 924 to convert the response from the language of the network site to the language identified of mobile device 920. In an embodiment, response 912 is identified by agent 950 as being in HTML or CHTML. The response 912 is then converted to HDML for mobile device 920.

The protocol of response 912 is identified by agent 950 and converted by protocol conversion module 922 to the protocol of mobile device 920. In an embodiment, response 912 is communicated to engine 910 using the HTTP protocol. The protocol conversion module 922 converts the response 912 to WAP.

The response is then signaled to mobile device 920. The mobile device 920 is able to use the communication protocol of the network. In addition, mobile device 920 can communicate with network sites programmed in languages other than the one used by the mobile device. Further, the natural languages used by the network sites do not preclude the mobile device 920 from accessing the network sites.

An embodiment of the invention enables a system for developing an agent to implement specific conversion modules, according to characteristics defined by an operator. The agent may be made particular to a specific network site, and equipped to identify a plurality of characteristics of the mobile device.

As an example, a web site may host a business application for employees or customers. An operator may desire to make the web-site accessible to mobile devices having certain characteristics. Further, the operator may wish to accommodate formats of different types of devices.

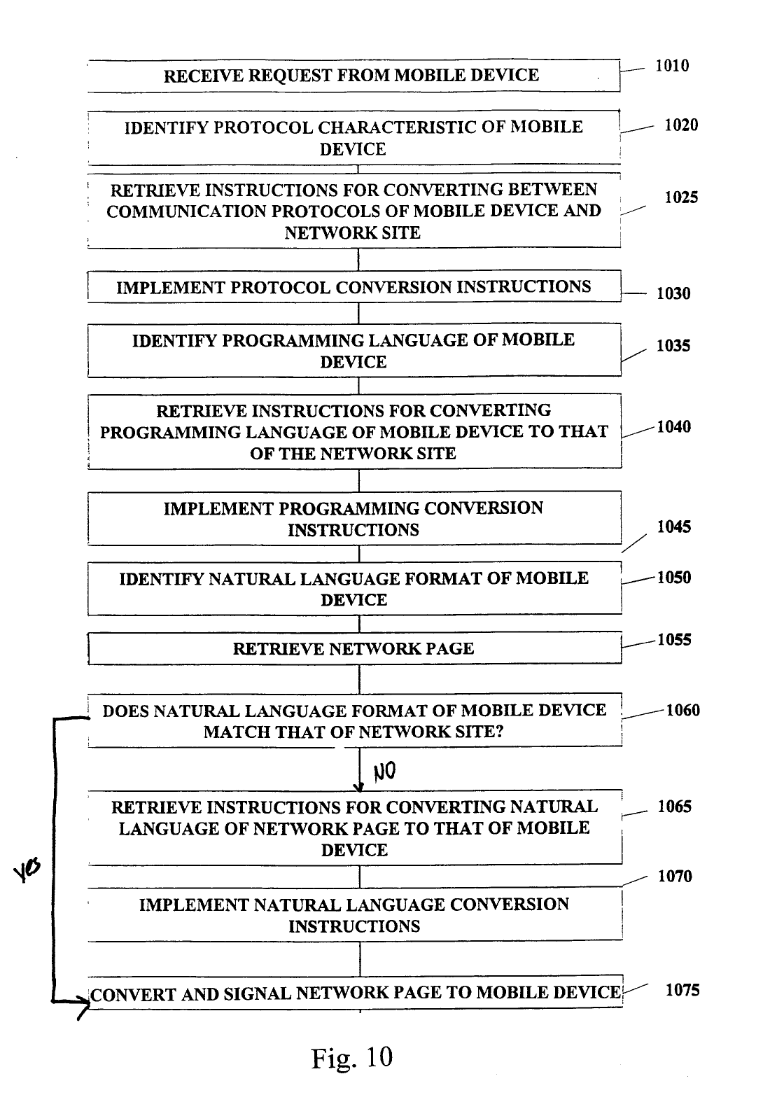

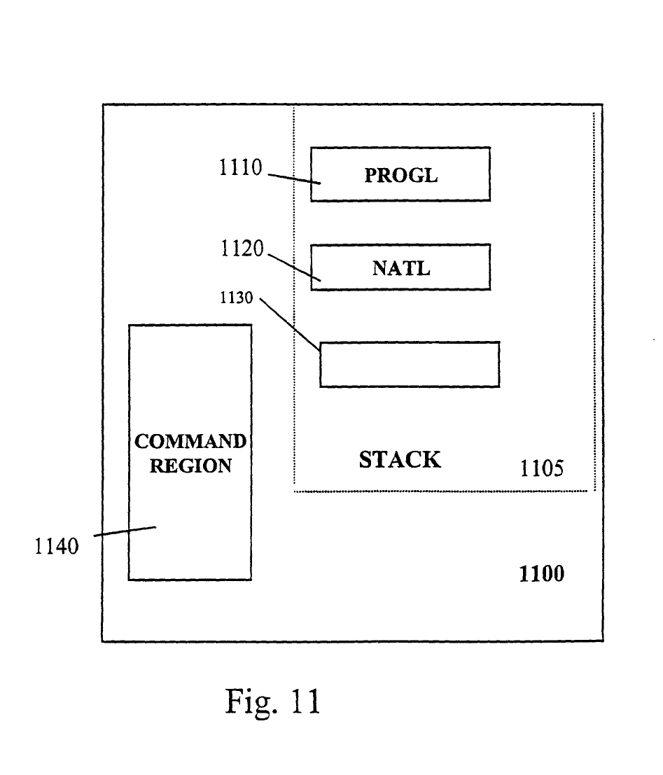

FIG. 10 illustrates a process for identifying characteristics of mobile devices accessing a select network-site, and for converting the identified characteristics to enable communications between the mobile device and network site. In this embodiment, the conversion engine 910 is associated with a particular network site. That is, communications from mobile devices have to be directed to the network site in order for the process to be implemented. The conversion engine 910 may be implemented with the server hosting the network site, or may be included as a system remote to that server.

In step 1010, a request is received from mobile device 920. The request includes identification for mobile device 920. In step 1020, the protocol characteristics of the mobile device are identified. In step 1025, the protocol conversion instructions for converting between the protocol identified for the mobile device 920 (i.e. WAP) and the protocol (i.e. IP) of the network site are retrieved. In step 1030, the protocol conversion instructions are implemented, so that the request from the mobile device is converted to the protocol of the network site. In an embodiment, the steps of retrieving and implementing the protocol conversion instructions are implemented by protocol conversion module 922. This may involve converting WAP requests to IP requests such as HTTP or POP3/SMTP.

In step 1035, the programming and mark-up language of mobile device 920 is identified from the request. For example, the programming and mark-up language of the mobile device may be identified as being one of either WML, HDML or CHTML. In step 1040, instructions for converting the programming and mark-up language of the mobile device 920 to that of the network site (i.e. HTML) are retrieved from database 940. The instructions are implemented in step 1045. In an embodiment, the steps of retrieving and implementing the conversion instructions for the programming and mark-up language are performed using programming and mark-up language module 924.

In step 1050, the natural language format of the mobile device 920 is identified from the request. For example, the request may identify the mobile device 920 by a useragent identifier. The type of device may be matched to a natural language format using a look-up table. In another example, the request may contain a two letter language identifier.

The request signaled from mobile device 920 to the network site is provided a response from the network site in step 1055. The response may be in the form of a network page. In step 1060, a determination is made as to whether the natural language format of the mobile device 920 matches that of the content requested from the network site. If the determination is negative, then in step 1065, instructions for converting the network language format to the natural language format of the network site are retrieved. In step 1070, the instructions are implemented, so that content is formatted for the natural language of the mobile device. In step 1075, programming and mark-up language conversion is done and the converted network content is then signaled to the mobile device 920.

As an example of an embodiment described with FIGS. 9 and 10, an HTML coded web-site includes Japanese and English style natural language formats. The target audience of wireless visitors is intended to include WAP devices, programmed in, for example, WML, HDML, or CHTML wireless mark-up languages. The wireless visitors may be expected to use one of either English or Japanese formatted devices. The agent 950 is instructed to identify each mobile device, and to route communications from the mobile device to a protocol conversion module, as well as a programning module for converting the specific language format of the communication from the mobile device 920 to that of the network site. The agent 950 is also programmed to convert the response from the network site to the programming and mark-up language of the mobile device 920. If mobile device 920 is determined to be a Japanese formatted device, agent 950 will direct the network page to natural language module 926, which retrieves instructions from database 940. The instructions are implemented to convert the English format on the network site to Japanese format. The network page is also sent to protocol conversion module 922, to convert the protocol from IP to WAP.

Embodiments such as described with FIGS. 9 and 10 may be used to mobilize content on network sites. For example, the content on the network site may be made accessible for an audience using mobile devices 920. The mobilization of the network site may be a one-time event, requiring only that agent 950 recognize select types of programming and mark-up languages, natural language formats, communication protocols, and/or other communication exchange characteristics. It may also be real-time, performed with each mobile request.

The instruction sets retrieved in embodiments described with FIGS. 9 ad 10 may be implemented in the manner described in FIG. 1. To this end, an operator-interface 1100 may be implemented to enable operators to identify conversion modules for a particular network site. An operator-interface 1100 enables users to create a stack 1105. The operator selects a network address for each stack 1105. Each stack 1105 is characterized by one or more communication characteristics. The stack is called when a subscriber of a service uses the mobile device 920 to request the network site associated with stack 1105.

In an embodiment, each stack 1105 includes selection fields 1110, 1120, and 1130. The first selection field 1110 may be used by the operator to select a programming conversion module matching the programming of the mobile device. For example, the operator may select HDML This enables agent 950 to route communications to and from an HDML type mobile device 920 through program conversion module 924. The program conversion module 924 is signaled to retrieve instructions from database 940 for converting communications to and from HDML. Examples of selection fields 1110-1130 include user-interactive features such as menus and text-fields.

The second selection field 1120 may be used to select a natural language format. Examples of selections that can be made for the second selection field 1120 include Japanese, English, French or German. Communications from the network site may then be formatted to account for the selected natural language format.

The third selection field 1130 may be used to specify a third characteristic for communications between a network site and a mobile device. For example, the third selection field 1130 may be used to select a communication protocol, screen size, communication rate etc.

In addition, an embodiment may provide selectable commands that can be associated with each stack 1105. The commands may be listed or otherwise provided in a command region on 1140 of the operator-interface 1100. For example, the commands may include add text. The operator may select this command and type in a message that is to appear when the stack is selected. Other examples of commands that may be used with each stack are provided in the description of FIG. 5.

It will be appreciated that the network site provides mobile solutions for an expected audience using mobile devices, while minimizing the amount of bandwidth required to provide the solutions. For example, by transmitting only the smaller converted content across the wireless network, bandwidth efficiency and use is maximized. Further, the extra heavy content of the network site is not needlessly accessed by mobile devices.

An advantage provided with an embodiment of the invention is that the operator requires minimal skill to create stack 1105. The use of operator-interface 1100 provides a GUI-oriented, intuitive, and friendly mechanism for enabling operators to provide the mobile solutions. Further, mobile solutions can be provided with reduced coding, and virtually no conversion time. Programming is not needed by operators to make network content accessible to a wide and select range of mobile devices.

The foregoing description of various embodiments of the invention has been presented for purposes of illustration and description. It is not intended to limit the invention to the precise forms disclosed. Many modifications and equivalent arrangements will be apparent.

What is claimed is:

1. A method for delivering content to a mobile device from a network site where the mobile device and network site may each employ different communication protocols, programming and mark-up languages, and/or natural language formats relative to each other, the method comprising:
receiving a communication from a mobile device corresponding to a request for content from a network site;
identifying a communication protocol, a programming and mark-up language, and a natural language format employed by the mobile device;
determining which of the identified communication protocols, programming and mark-up languages, and natural language formats differ between the mobile device and the network site;
modifying the content in regard to whichever of the communication protocol, programming and mark-up language, and natural language format of the content differs between the mobile device and the network site such that each of the communication protocol, programming and mark-up language, and natural language format of the converted content matches the communication protocol, programming and mark-up language, and natural language format of the mobile device; and
transmitting the converted content to the mobile device in the communication protocol, programming and mark-up language, and natural language format of the mobile device.

2. A method according to claim 1, further comprising identifying a communication protocol, a programming and mark-up language, and a natural language format employed by the network site prior to determining which differ.

3. A method according to claim 1, wherein identifying a communication protocol, a programming and mark-up language, and a natural language format employed by the mobile device comprises accessing a database comprising communication protocol, programming and mark-up language, and natural language format properties of different types of mobile devices.

4. A method according to claim 1, wherein identifying a communication protocol, a programming and mark-up language, and a natural language format employed by the network site comprises accessing a database comprising communication protocol, programming and mark-up language, and natural language format properties of different network sites.

5. A method according to claim 1, wherein identifying a communication protocol, a programming and mark-up language, and a natural language format employed by the network site comprises querying the network site.

6. A method according to claim 1, wherein identifying a communication protocol, a programming and mark-up language, and a natural language format employed by the mobile device uses a serial number, device ID, or useragent and other request header information of the mobile device to make the identifications.

7. A device for delivering content to a mobile device from a network site where the mobile device and network site may each employ different communication protocols, programming and mark-up languages, and/or natural language formats relative to each other, the device comprising:
computer executable logic taking a communication received from a mobile device corresponding to a request for content from a network site and identifying a communication protocol, a programming and mark-up language, and a natural language format employed by the mobile device;
computer executable logic for determining which of the identified communication protocols, programming and mark-up languages, and natural language formats differ between the mobile device and the network site;
computer executable logic for modifying the content in regard to whichever of the communication protocol, programming and mark-up language, and natural language format of the content differs between the mobile device and the network site such that each of the communication protocol, programming and mark-up language, and natural language format of the converted content matches the communication protocol, programming and mark-up language, and natural language format of the mobile device; and
computer executable logic for causing the converted content to be transmitted to the mobile device in the communication protocol, programming and mark-up language, and natural language format of the mobile device.

8. A device according to claim 7, further comprising logic for identifying a communication protocol, a programming and mark-up language, and a natural language format employed by the network site.

9. A device according to claim 7, wherein the logic for identifying a communication protocol, a programming and mark-up language, and a natural language format employed by the mobile device accesses a database comprising communication protocol, programming and mark-up language, and natural language format properties of different types of mobile devices.

10. A device according to claim 7, wherein the logic for identifying a communication protocol, a programming and mark-up language, and a natural language format employed by the network site accesses a database comprising communication protocol, programming and mark-up language, and natural language format properties of different network sites.

11. A device according to claim 7, wherein the logic for identifying a communication protocol, a programming and mark-up language, and a natural language format employed by the network site queries the network site.

12. A device according to claim 7, wherein the logic for identifying a communication protocol, a programming and mark-up language, and a natural language format employed by the mobile device uses a serial number, device ID, or useragent and other request header information of the mobile device to make the identifications.

13. A device according to claim 7, wherein the logic for converting the communications to be exchanged is capable of converting the communication between at least two different protocols.

14. A device according to claim 7, wherein the logic for converting the communications to be exchanged is capable of converting the communication between at least three different protocols.

15. A device according to claim 7, wherein the logic for converting the communications to be exchanged is capable of converting the communication between at least two different programming and mark-up languages.

16. A device according to claim 7, wherein the logic for converting the communications to be exchanged is capable of converting the communication between at least three different programming and mark-up languages.

17. A device according to claim 7, wherein the logic for converting the communications to be exchanged is capable of converting the communication between at least two different natural language formats.

18. A device according to claim 7, wherein the logic for converting the communications to be exchanged is capable of converting the communication between at least three different natural language formats.

19. A device according to claim 7, wherein the logic for identifying a communication protocol, a programming and mark-up language, and a natural language format employed by the mobile device uses a serial number, device ID, or useragent and other request header information of the mobile device to make the identifications.

20. A device according to claim 7, wherein the logic for converting the communications to be exchanged is capable of converting the communication to be exchanged between program languages selected from the group consisting of, for example, HDML, WML, HTML, MML and CHTML.

21. A device according to claim 7, wherein the logic for converting the communications to be exchanged is capable of converting the communications between natural language formats for countries and geographic regions selected from the group consisting of, for example, Japan, United States of America, Korea, China and Europe.

22. A device according to claim 7, further comprising computer executable logic for providing a user interface by which a range of different mobile devices which may access content from the network site may be defined.

23. A device according to claim 7, further comprising computer executable logic for providing a user interface by which a range of different mobile devices which may access content from the network site may be defined based on the natural language format employed by the mobile device.

24. A device according to claim 7, further comprising computer executable logic for providing a user interface by which a range of different mobile devices which may access content from the network site may be defined based on the programming and mark-up language employed by the mobile device.

25. A device according to claim 7, further comprising computer executable logic for providing a user interface by which a range of different mobile devices which may access content from the network site may be defined based on the communication protocol employed by the mobile device.

26. A device according to claim 7, further comprising computer executable logic for providing a graphical user interface to enable the rapid development of mobile applications by aiding the process of aggregating instruction sets to be executed in batches.
